(19) United States
(12) Patent Application Publication
(10) Pub. No.: US 2025/0145054 A1
(43) Pub. Date: May 8, 2025

(54) SYSTEM AND METHOD FOR CONTROLLING OUTPUT OF HIGH-VOLTAGE BATTERY FOR VEHICLE, AND VEHICLE HAVING SAME

(71) Applicants: HYUNDAI MOTOR COMPANY, SEOUL (KR); KIA CORPORATION, SEOUL (KR)

(72) Inventor: Hyun Soo Park, Seoul (KR)

(73) Assignees: HYUNDAI MOTOR COMPANY, SEOUL (KR); KIA CORPORATION, SEOUL (KR)

(21) Appl. No.: 18/654,447

(22) Filed: May 3, 2024

(30) Foreign Application Priority Data
Nov. 8, 2023 (KR) 10-2023-0153622

(51) Int. Cl. B60L 58/22; B60L 58/14

(52) U.S. Cl. CPC B60L 58/22; B60L 58/14; B60L 2240/547

(57) ABSTRACT

A system and a method for actively controlling the output of a high-voltage battery for a vehicle in response to a state of the high-voltage battery is disclosed. and The system includes a first controller monitoring a state of a main high-voltage battery, and a second controller monitoring a state of an auxiliary high-voltage battery, and when the first controller detects that the auxiliary high-voltage battery is mounted on the vehicle, the first controller may control the main high-voltage battery and the auxiliary high-voltage battery based on a required output of the vehicle, status information about the main high-voltage battery, and status information about the auxiliary high-voltage battery.

### CROSS REFERENCE TO RELATED APPLICATIONS

The present application claims priority to Korean Patent Application No. 10-2023-0153622, filed Nov. 8, 2023, the entire contents of which is incorporated herein for all purposes by this reference.

### BACKGROUND

### 1. Technical Field

The present disclosure relates to output control for a high-voltage battery for a vehicle. More particularly, the present disclosure relates to a system and a method for controlling the output of high-voltage battery for a vehicle, and a vehicle having the same, the system being capable of actively controlling the output of the high-voltage battery mounted on a vehicle in response to a state of the high-voltage battery.

### 2. Description of the Related Art

In recent, research on vehicles equipped with high-voltage batteries is increasing, and various types of eco-friendly vehicles such as electric vehicles, hybrid vehicles, and hydrogen fuel cell vehicles are being developed.

These vehicles are equipped with high-voltage batteries as a power source, and in controlling the vehicle, it is very important to properly control the output of the high-voltage battery.

Currently, a single high-voltage battery having the form of a pack is installed in the vehicle, but in the future, two or more high-voltage battery packs may be mounted and operated on the vehicle for efficient operation of the vehicle.

Therefore, a method to appropriately control the output of two or more high-voltage battery packs mounted on the vehicle is required.

The foregoing is technical information that the inventor possessed to derive the present disclosure or was acquired in the process of deriving the present disclosure, and is not necessarily the related art that was disclosed to the general public prior to the filing of the present disclosure.

### SUMMARY

The embodiments disclosed in the present disclosure were proposed in response to the above mentioned problem, and the present disclosure has a technical objective of providing a system and a method for actively controlling the output of a high-voltage battery mounted on a vehicle, and a vehicle having the same.

Another objective of the present disclosure is to provide a system and a method for actively controlling the output of a main battery and the output of an auxiliary battery when a required output of a vehicle is equal to or greater than an available output of the main battery, and a vehicle having the same.

Yet another objective of the present disclosure is to provide a system and a method for actively controlling the output of a main battery and the output of an auxiliary battery when the main battery continues to be operated in a discharge mode or a charge mode beyond a preset reference time, and a vehicle having the same.

Still another objective of the present disclosure is to provide a system and a method for actively controlling the output of a main battery and the output of an auxiliary battery when continuous discharge accumulated energy of the main battery or continuous charge accumulated energy thereof is equal to or greater than a preset reference value, and a vehicle having the same.

Still another objective of the present disclosure is to provide a system and a method for actively controlling the output of a main battery and the output of an auxiliary battery when an upward slope or a downward slope of cell voltage of the main battery is equal to or greater than a preset reference slope, or when cell voltage of the main battery exceeds a preset upper limit value or a preset lower limit value, and a vehicle having the same.

The technical problem to be achieved in the present disclosure is not limited to the above mention, and other problem intended by the present disclosure will be clearly understood by those skilled in the art from the description below.

As a technical means to achieve the above-mentioned technical problem, the present disclosure relates to controlling the output of a high-voltage battery for a vehicle and, more particularly, there may be provided a system and a method for actively controlling the output of a high-voltage battery mounted on a vehicle in response to a state of the high-voltage battery, and a vehicle having the same.

A system for controlling output of the high-voltage battery for a vehicle may include a first controller monitoring a state of a main high-voltage battery, and a second controller monitoring a state of a auxiliary high-voltage battery.

The first controller may control the main high-voltage battery and the auxiliary high-voltage battery, based on required output of the vehicle, status information about the main high-voltage battery, and status information about the auxiliary high-voltage battery.

The first controller may determine whether or not the required output of the vehicle is maximum required output of the vehicle, and when the required output of the vehicle is the maximum required output of the vehicle, the first controller may control the main high-voltage battery and the auxiliary high-voltage battery so that the main high-voltage battery and the auxiliary high-voltage battery output maximum power, respectively.

The first controller may determine whether or not the required output of the vehicle is the maximum required output of the vehicle, and when the required output of the vehicle is less than the maximum required output of the vehicle, the first controller may control the main high-voltage battery and the auxiliary high-voltage battery, based on a result obtained by comparing a value, the value being obtained by multiplying an available output of the main high-voltage battery by a conversion proportionality constant (α, 0<α<1), to the required output of the vehicle.

When the required output of the vehicle is less than or equal to the value obtained by multiplying the available output of the main high-voltage battery by the conversion proportionality constant, the first controller may block output of the auxiliary high-voltage battery and control the main high-voltage battery so that the main high-voltage battery outputs power corresponding to the required output of the vehicle.

When the required output of the vehicle is greater than the value obtained by multiplying the available output of the main high-voltage battery by the conversion proportionality constant, the first controller may control the main high-voltage battery so that the main high-voltage battery outputs power corresponding to the value obtained by multiplying the available output of the main high-voltage battery by the conversion proportionality constant, and the first controller may control the auxiliary high-voltage battery so that the auxiliary high-voltage battery outputs power corresponding to a value obtained by subtracting the output of the main high-voltage battery from the required output of the vehicle.

The first controller may determine whether or not the required output of the vehicle is less than a preset threshold value, and when the required output of the vehicle is less than the threshold value, the first controller may control the main high-voltage battery and the auxiliary high-voltage battery based on a result of determination of whether or not an operational duration of the main high-voltage battery exceeds a preset time limit.

When the operational duration of the main high-voltage battery exceeds the time limit, the first controller may control the auxiliary high-voltage battery so that the auxiliary high-voltage battery outputs maximum power, and control the main high-voltage battery so that the main high-voltage battery outputs power corresponding to a value obtained by subtracting the output of the auxiliary high-voltage battery from the required output of the vehicle.

When the operational duration of the main high-voltage battery does not exceed the time limit, the first controller may control the main high-voltage battery so that the main high-voltage battery outputs power corresponding to the required output of the vehicle.

When the operational duration of the main high-voltage battery does not exceed the time limit, the first controller mya control the main high-voltage battery and the auxiliary high-voltage battery based on a result of determination of whether or not continuous operation accumulated energy of the main high-voltage battery exceeds a preset limit value of accumulated energy.

When the continuous operation accumulated energy of the main high-voltage battery exceeds the preset limit value of accumulated energy, the first controller may control the auxiliary high-voltage battery so that the auxiliary high-voltage battery outputs maximum power, and control the main high-voltage battery so that the main high-voltage battery outputs power corresponding to a value obtained by subtracting the output of the auxiliary high-voltage battery from the required output of the vehicle.

When the continuous operation accumulated energy of the main high-voltage battery does not exceed the preset limit value of accumulated energy, the first controller may control the main high-voltage battery so that the main high-voltage battery outputs power corresponding to the required output of the vehicle.

The first controller may control the main high-voltage battery and the auxiliary high-voltage battery based on a result of determination of whether or not continuous operation accumulated energy of the main high-voltage battery exceeds a preset limit value of accumulated energy.

When the continuous operation accumulated energy of the main high-voltage battery exceeds the preset limit value of accumulated energy, the first controller may control the auxiliary high-voltage battery so that the auxiliary high-voltage battery outputs maximum power, and control the main high-voltage battery so that the main high-voltage battery outputs power corresponding to a value obtained by subtracting the output of the auxiliary high-voltage battery from the required output of the vehicle.

When the continuous operation accumulated energy of the main high-voltage battery does not exceed the preset limit value of accumulated energy, the first controller may control the main high-voltage battery so that the main high-voltage battery outputs power corresponding to the required output of the vehicle.

The first controller may control the main high-voltage battery and the auxiliary high-voltage battery based on at least one selected from a group consisting of a change slope value of cell voltage of the main high-voltage battery, maximum cell voltage thereof, and minimum cell voltage thereof.

When the change slope value of cell voltage of the main high-voltage battery is greater than a preset slope reference value, the maximum cell voltage of the main high-voltage battery is greater than a preset cell voltage upper limit value, or the minimum cell voltage of the main high-voltage battery is less than a preset cell voltage lower limit value, the first controller may reduce an available output of the main high-voltage battery according to a preset slew rate.

The first controller may control the main high-voltage battery so that the main high-voltage battery outputs power corresponding to a value obtained by subtracting the reduced output according to the slew rate from the available output of the main high-voltage battery, and control the auxiliary high-voltage battery so that the auxiliary high-voltage battery outputs power corresponding to a value obtained by adding the reduced output to a current output of the auxiliary high-voltage battery.

When the change slope value of cell voltage of the main high-voltage battery is less than or equal to a preset slope reference value, the maximum cell voltage of the main high-voltage battery is less than or equal to a preset cell voltage upper limit value, and the minimum cell voltage of the main high-voltage battery is equal to or greater than a preset cell voltage lower limit value, the first controller may maintain available output of the main high-voltage battery and output of the auxiliary high-voltage battery.

According to the present disclosure, a method for controlling output of a high-voltage battery for a vehicle may include monitoring, by a first controller, a state of a main high-voltage battery; monitoring, by a second controller, a state of an auxiliary high-voltage battery; and when the auxiliary high-voltage battery is mounted on a vehicle, controlling, by the first controller, the main high-voltage battery and the auxiliary high-voltage battery, on a basis of a required output of the vehicle, status information about the main high-voltage battery, and status information about the auxiliary high-voltage battery.

According to the present disclosure, a vehicle may include a system for controlling output of a high-voltage battery for a vehicle, and the system for controlling output of a high-voltage battery for a vehicle may include a first controller monitoring a state of a main high-voltage battery; and a second controller monitoring a state of a auxiliary high-voltage battery, wherein when the first controller detects that the auxiliary high-voltage battery is mounted on a vehicle, the first controller may control the main high-voltage battery and the auxiliary high-voltage battery, on a basis of a required output of the vehicle, status information about the main high-voltage battery, and status information about the auxiliary high-voltage battery.

Specific details according to various examples of the present disclosure, other than the solutions mentioned above, are included in the description and the drawings below.

According to the embodiments of the present disclosure, the required output of the vehicle is equal to or greater than the available output of the main battery, the present disclosure can provide the method for actively controlling the output of the main battery and the output of the auxiliary battery.

According to the embodiment of the present disclosure, the present disclosure can provide the method for actively controlling the output of the main battery and the output of the auxiliary battery when the main battery continues to be operated in the discharge mode or the charge mode beyond the preset reference time.

According to the embodiment of the present disclosure, the present disclosure can provide the method for actively controlling the output of the main battery and the output of the auxiliary battery when the continuous discharge accumulated energy of the main battery or the continuous charge accumulated energy is equal to or greater than the preset reference value.

According to the embodiment of the present disclosure, the present disclosure can provide the method for actively controlling the output of the main battery and the output of the auxiliary battery when an upward slope value of cell voltage of the main battery is equal to or greater than the preset upward slope reference value or a downward slope value of cell voltage of the main battery is equal to or greater than the preset reference downward slope value.

According to the embodiment of the present disclosure, the present disclosure can provide the method for actively controlling the output of the main battery and the output of the auxiliary battery when cell voltage of the main battery exceeds the preset upper limit value or lower limit value.

According to the embodiment of the present disclosure, the present disclosure can actively control the high-voltage main battery and the high-voltage auxiliary battery mounted on the vehicle. Accordingly, the efficiency of the high-voltage battery and the performance of the vehicle can be improved.

The effect of the present disclosure is not limited to the above mention, and other effects not mentioned will be clearly understood by those skilled in the art from the description below.

Since the contents of the objectives to be solved, the solution for the objectives, and the effects mentioned above do not specify the essential features of the claims, the right scope of the claims is not limited by the matters in the detailed description of the present disclosure.

### BRIEF DESCRIPTION OF THE FIGURES

The drawings attached below are intended to aid understanding of the embodiments of the present disclosure, and provide the embodiments along with detailed descriptions. However, the technical features of the embodiments are not limited to specific drawings, and the features disclosed in each drawing may be combined to form a new embodiment.

FIG. 1 is a view showing a system for controlling the output of a vehicle including a high-voltage battery according to the present disclosure.

FIG. 2 is a flowchart showing a method for controlling the output of the high-voltage battery according to a first embodiment of the present disclosure.

FIG. 3 is a flowchart showing a method for controlling the output of the high-voltage battery according to a second embodiment of the present disclosure.

FIG. 4 is a flowchart showing a method for controlling the output of the high-voltage battery according to a third embodiment of the present disclosure.

FIG. 5 is a flowchart showing a method for controlling the output of the high-voltage battery according to a fourth embodiment of the present disclosure.

FIG. 6 is a view showing detailed configuration of a first controller according to the present disclosure.

### DETAILED DESCRIPTION

The above and other objects, features and advantages of embodiments of the present disclosure, and a method of achieving them will be more clearly understood with reference to the embodiments described below in detail in conjunction with the accompanying drawings. However, the present disclosure is not limited to the following embodiments, and can be embodied in various forms different from each other, and embodiments of the present disclosure are presented to make complete disclosure of the present disclosure and help those who are ordinarily skilled in the art to which the present disclosure belongs understand the present disclosure. The present disclosure is only defined by the scope of the claims.

The shape, size, ratio, angle, number, etc. disclosed in the drawings for describing the embodiments of the present disclosure are illustrative and are not limited to the matters in which the present disclosure is shown. The same reference numerals are used throughout the specification to designate the same or similar components. In the following description, it is to be noted that, when the functions of conventional components and the detailed description of components related with the present disclosure may make the gist of the present disclosure unclear, a detailed description of those components will be omitted. When “comprise”, “include”, “consist of”, etc. mentioned in this specification are used, other parts may be added unless “only” is used. Singular forms expressing components are intended to include plural forms unless specifically stated otherwise.

When interpreting a component, even when there is no separate explicit description of an error range, the error range is interpreted to be included.

In the case of the description of a temporal relationship, when a temporal relationship is described with “after”, “sequentially”, “next”, “before”, etc., non-sequential cases may also be included unless “immediately” or “directly” is used.

Although first, second, etc. are used to describe various components, these components are not limited by these terms. These terms are merely used to distinguish one component from another. Accordingly, a first component mentioned below may be a second component within the technical idea of the present disclosure.

Further, when describing the components of the present disclosure, terms such as first, second, A, B, (a) or (b) may be used. Since these terms are provided merely for the purpose of distinguishing the components from each other, they do not limit the nature, sequence or order of the components. When a component is described as being “connected”, “coupled”, or “connected” to another component, it should be understood that the component is directly connected to another component, and unless specifically mentioned otherwise, the components may be indirectly connected to each other or a component may be “interposed” between the components.

“At least one of” include all combinations of one or more of the associated components. For example, “at least one of first, second, and third components” means not only the first, second, or third component, but also all combinations of two or more of the first, second, and third components.

Each feature of the various embodiments of the present specification may be partially or entirely coupled to or combined with each other, and may be technically linked and operated in various ways, and embodiments may be implemented independently of each other or together in a related relationship.

Hereinbelow, a system and a method for controlling the output of a high-voltage battery for a vehicle according to the present disclosure, and a vehicle including the same will be described with reference to accompanying drawings.

The scale of components shown in the drawings is different from the actual scale for convenience of description, and is not limited to the scale shown in the drawings.

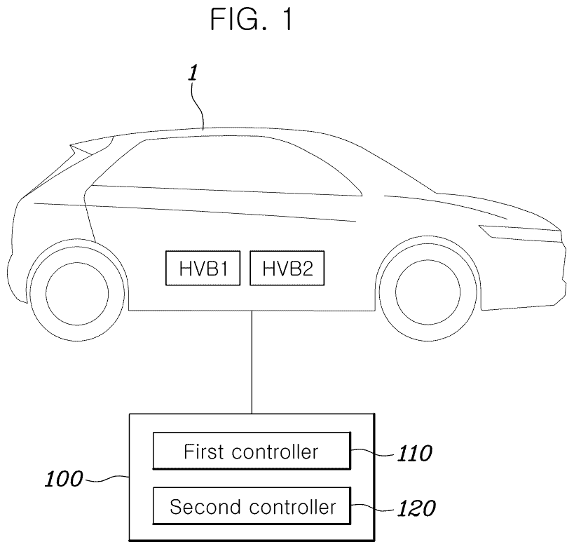

FIG. 1 is a view showing a system for controlling the output of a vehicle including a high-voltage battery according to the present disclosure.

Referring to FIG. 1, a vehicle 1 may include a system 100 for controlling the output of a high-voltage battery according to the present disclosure.

The vehicle 1 may be a vehicle equipped with a high-voltage battery as a power source. For example, the vehicle 1 may be electric vehicles (EV), hybrid electric vehicles (HEV), plugin hybrid electric vehicles (PHEV), fuel cell electric vehicles (FCEV), etc.

The system 100 for controlling the output of a high-voltage battery according to the embodiment may control the output of a plurality of high-voltage batteries HVB1, HVB2 mounted on the vehicle 1. In the embodiment, the two high-voltage batteries HVB1 and HVB2 are mounted on the vehicle 1, one HVB1 of the high-voltage batteries may be a main high-voltage battery, and the other high-voltage battery HVB2 may be an auxiliary high-voltage battery.

The high-voltage battery HVB1, HVB2 may be implemented into a form in which a plurality of battery modules consisting of a plurality of cells is packed. In other words, the high-voltage battery HVB1, HVB2 may be implemented into a form of a pack.

Hereinbelow, the high-voltage battery HVB1 is expressed as “a main battery”, and the high-voltage battery HVB2 is expressed as “an auxiliary battery”.

According to the embodiment, the system 100 for controlling the output of a high-voltage battery may include a first controller 110 (or a first battery controller) and a second controller 120 (or a second battery controller). For example, the first controller 110 and the second controller 120 may be a battery management system (BMS).

The first controller 110 may monitor a state of the main battery HVB1, and the second controller 120 may monitor a state of the auxiliary battery HVB2.

The first controller 110 may determine voltage, current, state of charge (SOC), state of health (SOH), an operational mode, cell voltage, etc. of the main battery HVB1.

The second controller 120 may determine voltage, current, SOC, SOH, an operational mode, cell voltage, etc. of the auxiliary battery HVB2.

The second controller 120 may provide the status information about the auxiliary battery HVB2 to the first controller 110. For example, the status information of the auxiliary battery HVB2 may include voltage, current, SOC, SOH, an operational mode, cell voltage, etc. of the auxiliary battery HVB2, and a type of information included in the status information of the auxiliary battery HVB2 is not limited thereto, and the status information thereof may include a variety of information required for operation of the first controller 110.

The first controller 110 may determine whether or not the auxiliary battery HVB2 is mounted, and when it is determined that the auxiliary battery HVB2 is mounted, the first controller 110 may perform control according to the present disclosure.

For example, the first controller 110 may determine whether or not the auxiliary battery HVB2 is mounted by controller area network (CAN) communication or wire connection.

According to the embodiment, the first controller 110 may receive a mounting recognition signal from the second controller 120 to determine whether or not the auxiliary battery HVB2 is mounted.

To this end, when the auxiliary battery HVB2 is mounted on the vehicle 1, the second controller 120 may output the mounting recognition signal to the first controller 110.

According to the embodiment, the first controller 110 may determine whether or not the auxiliary battery HVB2 is mounted, based on change in voltage of a wire connecting the main battery HVB1 to the auxiliary battery HVB2.

According to the embodiment, the first controller 110 may receive a required output of the vehicle from an upper controller, and may control the output of the main battery HVB1 and the output of the auxiliary battery HVB2 based on the required output of the vehicle.

The upper controller may include hybrid control Units (HCU), vehicle control units (VCU), etc., and is not limited thereto.

The required output of a vehicle may be the output of a high-voltage battery that is required to drive the vehicle 1.

According to the embodiment, the first controller 110 may compare the required output of the vehicle and an available output of the main battery HVB1, and in response to a comparison result, the first controller 110 may control the output of the main battery HVB1 and the output of the auxiliary battery HVB2.

When the required output of the vehicle is equal to or greater than a predetermined level in comparison to the available output of the main battery HVB1, the first controller 110 may control the auxiliary battery HVB2 so that the auxiliary battery HVB2 outputs power.

According to the embodiment, the first controller 110 may control the main battery HVB1 so that the main battery HVB1 outputs power corresponding to a value obtained by multiplying the available output of the main battery HVB1 by a conversion proportionality constant (α, 0<α<1), and the first controller 110 may control the auxiliary battery HVB2 so that the auxiliary battery HVB2 outputs power obtained by subtracting the output of the main battery HVB1 from the required output of the vehicle.

The conversion proportionality constant α is a parameter that determines a ratio of the output of the main battery HVB1 and the output of the auxiliary battery HVB2. According to a value of the conversion proportionality constant α, the output of the main battery HVB1 and the output of the auxiliary battery HVB2 may be determined.

When the required output of the vehicle is the maximum required output of the vehicle, the first controller 110 may control the main battery HVB1 and the auxiliary battery HVB2 so that the main battery HVB1 and the auxiliary battery HVB2 output the maximum output, respectively.

According to the embodiment, when the first controller 110 determines that the main battery HVB1 is continuously operated in a discharge mode or a charge mode in excess of a preset reference time, based on the status information of the main battery HVB1, the first controller 110 may allow the auxiliary battery HVB2 to assist the main battery HVB1.

When the first controller 110 determines that the main battery HVB1 is operated in the discharge mode or the charge mode above the preset time limit, the first controller 110 may control the auxiliary battery HVB2 so that the auxiliary battery HVB2 outputs the maximum output, and the first controller 110 may control the main battery HVB1 so that the main battery HVB1 outputs power obtained by subtracting the output of the auxiliary battery HVB2 from the required output from the vehicle.

For example, the first controller 110 may determine whether or not a discharge duration of the main battery HVB1 exceeds a preset discharge duration time limit, and may determine whether or not charge duration time of the main battery HVB1 exceeds a preset charge duration time limit.

According to the embodiment, when the maximum output of the auxiliary battery HVB2 is equal to or greater than the required output of the vehicle, the first controller 110 may limit the output of the main battery HVB1. In other words, the maximum output of the auxiliary battery HVB2 is equal to or greater than the required output of the vehicle, the output of the main battery HVB1 is 0 kw.

For example, when the first controller 110 determines that the required output of the vehicle is less than a preset threshold value, the first controller 110 may determine whether or not the discharge duration time of the main battery HVB1 exceeds the discharge duration time limit, and may determine whether or not the charge duration time of the main battery HVB1 exceeds the charge duration time limit.

As described above, even when the output of the main battery HVB1 is low, it is possible to prevent the main battery HVB1 from being excessively used, and to prevent the main battery HVB1 from being deteriorated.

According to the embodiment, when the first controller 110 determines that continuous discharge accumulated energy (or power) or continuous charge accumulated energy of the main battery HVB1 exceeds a preset limit value of accumulated energy, based on the status information of the main battery HVB1, the first controller 110 may allow the auxiliary battery HVB2 to assist the main battery HVB1.

When the first controller 110 determines that the continuous discharge accumulated energy or the continuous charge accumulated energy of the main battery HVB1 exceeds the preset limit value of accumulated energy, the first controller 110 may control the auxiliary battery HVB2 so that the auxiliary battery HVB2 outputs the maximum power, and may control the main battery HVB1 so that the main battery HVB1 outputs power obtained by subtracting the output of the auxiliary battery HVB2 from the required output of the vehicle.

For example, the first controller 110 may determine whether or not the continuous discharge accumulated energy of the main battery HVB1 exceeds the preset limit value of continuous discharge accumulated energy, and may determine whether or not the continuous charge accumulated energy of the main battery HVB1 exceeds the preset limit value of continuous charge accumulated energy.

According to the embodiment, when the maximum output of the auxiliary battery HVB2 is equal to or greater than the required output of the vehicle, the first controller 110 may limit the output of the main battery HVB1. In other words, the maximum output of the auxiliary battery HVB2 is equal to or greater than the required output of the vehicle, the output of the main battery HVB1 is 0 kw.

For example, when the first controller 110 determines that discharge duration time of the main battery HVB1 is less than the discharge duration time limit or charge time of the main battery HVB1 is less than the charge duration time limit, the first controller 110 may determine whether or not the continuous discharge accumulated energy of the main battery HVB1 exceeds the limit value of continuous discharge accumulated energy, or may determine whether or not the continuous charge accumulated energy of the main battery HVB1 exceeds the limit value of continuous charge accumulated energy.

Accordingly, even when the output of the main battery HVB1 is low and a discharge duration or a charge duration of the main battery HVB1 does not exceed the preset time limit, it is possible to prevent the main battery HVB1 from excessively used and to prevent the main battery HVB1 from being deteriorated.

According to the embodiment, the first controller 110 may allow the auxiliary battery HVB2 to assist the main battery HVB1, based on change (upward slope or downward slope) of cell voltage of the main battery HVB1 or cell voltage of the main battery HVB1.

When a value of the upward slope of cell voltage of the main battery HVB1 is greater than a preset reference value of the upward slope, or a value of the downward slope of cell voltage of the main battery HVB1 is greater than a preset reference value of the downward slope, the first controller 110 may reduce the available output according to a preset slew rate.

When the maximum cell voltage of the main battery HVB1 is greater than a preset upper limit value of cell voltage, or the minimum cell voltage of the main battery HVB1 is less than a preset lower limit value of cell voltage, the first controller 110 may reduce the available output of the main battery HVB1 according to the preset slew rate.

For example, according to the present disclosure, the upper limit value of cell voltage and the lower limit value of cell voltage may be preset so that output control of the main battery HVB1 is performed before “a conventional output control by voltage”.

For example, the cell voltage upper limit value according to the present disclosure may be less than a cell voltage upper limit value applied to “the output control by voltage”, and the cell voltage lower limit value according to the present disclosure may be greater than a cell voltage lower limit value applied to “the output control by voltage”.

The first controller 110 may determine the output of the main battery HVB1 reduced according to the slew rate and may control the auxiliary battery HVB2 so that the auxiliary battery HVB2 outputs power corresponding to the reduced output of the main battery HVB1.

Accordingly, since the auxiliary battery HVB2 assists the output of the main battery HVB1 that is reduced according to the slew rate, the total output of the high-voltage battery HVB1, HVB2 may maintain the required output of the vehicle.

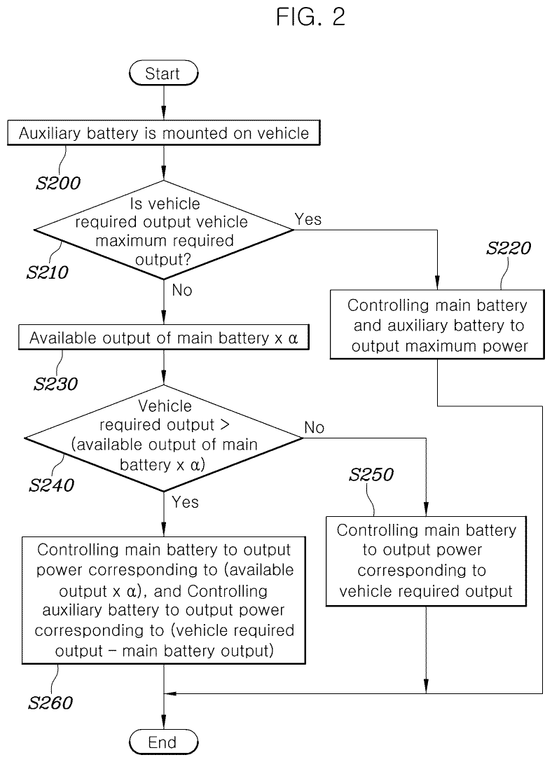

FIG. 2 is a flowchart showing a method for controlling output of the high-voltage battery according to a first embodiment of the present disclosure.

Referring to FIGS. 1 and 2, a method for controlling the output of the high-voltage battery according to a first embodiment of the present disclosure will be described.

First, when the first controller 110 recognizes that the auxiliary battery HVB2 is mounted on the vehicle 1, at S200, the first controller 110 may control the output of the main battery HVB1 and the output of the auxiliary battery HVB2, based on the required output of the vehicle and the available output of the main battery HVB1.

Specifically, the first controller 110 may determine whether or not the required output of the vehicle is the maximum required output, at S210.

As a result of the determination at S210, when the required output of the vehicle is the maximum required output of the vehicle at S210—Yes, the first controller 110 may control the main battery HVB1 and the auxiliary battery HVB2 so that the main battery HVB1 and the auxiliary battery HVB2 output the maximum power, respectively, at S220.

As a result of the determination at S210, when the required output of the vehicle is not the maximum required output of the vehicle, at S210—No, i.e., when the required output of the vehicle is less than the maximum required output of the vehicle, the first controller 110 may multiply the current available output of the main battery HVB1 by the preset conversion proportionality constant α (0<α<1), at S230.

Thereafter, the first controller 110 may determine whether or not the required output of the vehicle is greater than a value obtained by multiplying the current available output of the main battery HVB1 by the conversion proportionality constant α, at S240.

As a result of the determination at S240, when the required output is not greater than the value obtained by multiplying the available output of the main battery HVB1 by the conversion proportionality constant α, at S240—No, the first controller 110 may control the main battery HVB1 so that the main battery HVB1 outputs power corresponding to the required output of the vehicle, at S250.

At S250, the first controller 110 may block the output of the auxiliary battery HVB2.

In other words, when the required output of the vehicle is less than or equal to the value obtained by multiplying the available output of the main battery HVB1 by the conversion proportionality constant α, the output of the auxiliary battery HVB2 is blocked and the main battery HVB1 may supply power corresponding to the entire required output of the vehicle.

As a result of the determination at S240, when the required output of the vehicle is greater than the value obtained by multiplying the available output of the main battery HVB1 by the conversion proportionality constant α, at S240—Yes, the first controller 110 may control the main battery HVB1 so that the main battery HVB1 outputs power corresponding to the value obtained by multiplying the available output of the main battery HVB1 by the conversion proportionality constant α and may control the auxiliary battery HVB2 so that the auxiliary battery HVB2 outputs power obtained by subtracting the output of the main battery HVB1 from the required output of the vehicle, at S260.

In other words, when the required output of the vehicle is greater than the value obtained by multiplying the available output of the main battery HVB1 by the conversion proportionality constant α, the main battery HVB1 may output power corresponding to the value obtained by multiplying the available output by the conversion proportionality constant α, and the auxiliary battery HVB2 may output power obtained by subtracting the output of the main battery HVB1 from the required output of the vehicle.

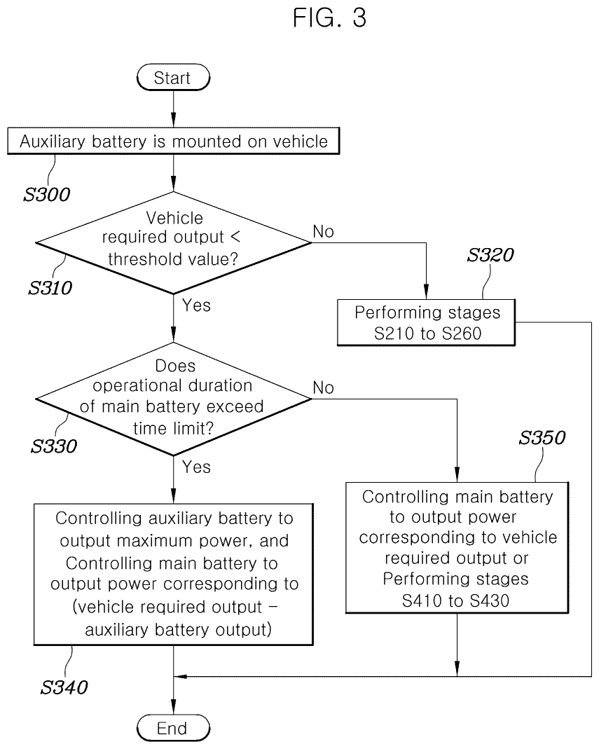

FIG. 3 is a flowchart showing a method for controlling the output of the high-voltage battery according to a second embodiment of the present disclosure.

Referring to FIGS. 1 to 3, a method for controlling the output of the high-voltage battery according to a second embodiment of the present disclosure will be described.

First, when the first controller 110 recognizes the auxiliary battery HVB2 mounted on the vehicle 1, at S300, the first controller 110 may determine whether or not the required output of the vehicle is less than a preset threshold value, at S310.

As a result of the determination at S310, when the required output of the vehicle is equal to or greater than the threshold value at S310—No, the first controller 110 may perform the stages S210 to S260 in FIG. 2, at S320.

As a result of the determination at S310, when the required output of the vehicle is less than the threshold value, at S310—Yes, the first controller 110 may determine whether or not an operational duration of the main battery HVB1 exceeds a preset time limit, at S330.

At S330, the first controller 110 may determine whether or not the discharge duration of the main battery HVB1 exceeds the preset discharge duration time limit, or whether or not the charge duration of the main battery HVB1 exceeds the preset charge duration time limit.

As a result of the determination at S330, when the operational duration of the main battery HVB1 exceeds the time limit at S330—Yes, the first controller 110 may control the auxiliary battery HVB2 so that the auxiliary battery HVB2 outputs the maximum power and control the main battery HVB1 so that the main battery HVB1 outputs power corresponding to a value obtained by subtracting the output of the auxiliary battery HVB2 from the required output of the vehicle, at S340.

At S340, when the maximum output of the auxiliary battery HVB2 is equal to or greater than the required output of the vehicle, the output of the main battery HVB1 is 0 kw.

As a result of the determination at S330, when the operational duration of the main battery HVB1 does not exceed the time limit (in other word, when the operational duration of the main battery HVB1 is within the time limit) at S330—No, the first controller 110 may control the main battery HVB1 so that the main battery HVB1 outputs power corresponding to the required output of the vehicle at S350.

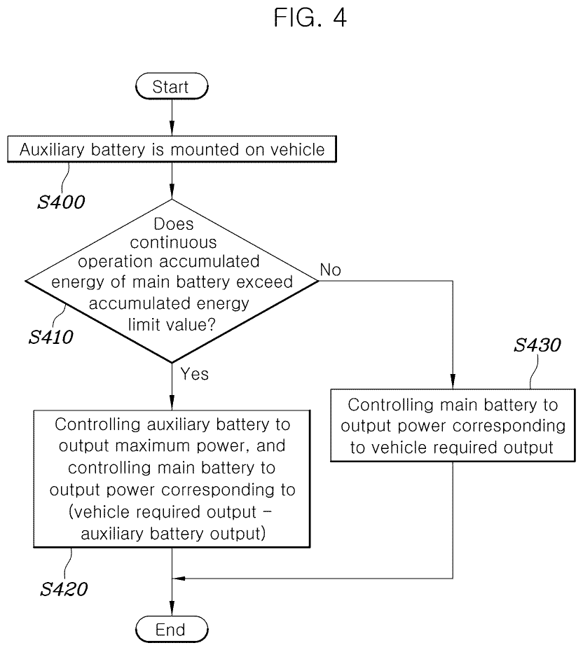

According to the embodiment, when the operational duration of the main battery HVB1 does not exceed the time limit at S330—No, the first controller 110 may determine, as shown in FIG. 4, whether or not continuous operation accumulated energy of the main battery HVB1 exceeds a preset limit value of accumulated energy, and may operate according to a result of the determination, at S410 to S430.

FIG. 4 is a flowchart showing a method for controlling the output of the high-voltage battery according to a third embodiment of the present disclosure.

Referring to FIGS. 1 to 4, a method for controlling the output of the high-voltage battery according to a third embodiment of the present disclosure will be described.

First, when the first controller 110 recognizes that the auxiliary battery HVB2 is mounted on the vehicle 1 at S400, the first controller 110 may determine whether or not the continuous operation accumulated energy of the main battery HVB1 exceeds the preset limit value of the accumulated energy at S410.

At S410, the first controller 110 may determine whether or not the continuous discharge accumulated energy of the main battery HVB1 exceeds the preset limit value of continuous discharge accumulated energy, or may determine whether or not the continuous charge accumulated energy of the main battery HVB1 exceeds the preset limit value of continuous charge accumulated energy.

As a result of the determination at S410, when the continuous operation accumulated energy of the main battery HVB1 exceeds the preset limit value of accumulated energy at S410—Yes, the first controller 110 may control the auxiliary battery HVB2 so that the auxiliary battery HVB2 outputs the maximum power and control the main battery HVB1 so that the main battery HVB1 outputs power corresponding to the value obtained by subtracting the output of the auxiliary battery HVB2 from the required output of the vehicle, at S420.

At S420, when the maximum output of the auxiliary battery HVB2 is equal to or greater than the required output of the vehicle, the output of the main battery HVB1 is 0 kw.

As a result of the determination at S410, when the continuous operation accumulated energy of the main battery HVB1 does not exceed the limit value of accumulated energy (that is, the continuous operation accumulated energy of the main battery HVB1 is within the limit value of accumulated energy) at S410—No, the first controller 110 may control the main battery HVB1 so that the main battery HVB1 outputs power corresponding to the required output of the vehicle at S430.

The method for controlling the output of the high-voltage battery according to the third embodiment shown in FIG. 4 may be performed in subordination to the method for controlling the output of the high-voltage battery according to the other embodiments.

According to the embodiment, the stages S410 to S430 shown in FIG. 4 may be performed in S350 in FIG. 3.

The case in which the stages S410 to S430 shown in FIG. 4 are performed in S350 in FIG. 3 will be described below.

When the operational duration of the main battery HVB1 does not exceed the time limit (that is, the operational duration of the main battery HVB1 is within the time limit) at S330—No, the first controller 110 may determine whether or not the continuous operation accumulated energy of the main battery HVB1 exceeds the preset limit value of the accumulated energy, at S410.

Furthermore, the first controller 110 may perform S420 or S430 in response to a result of the determination at S410.

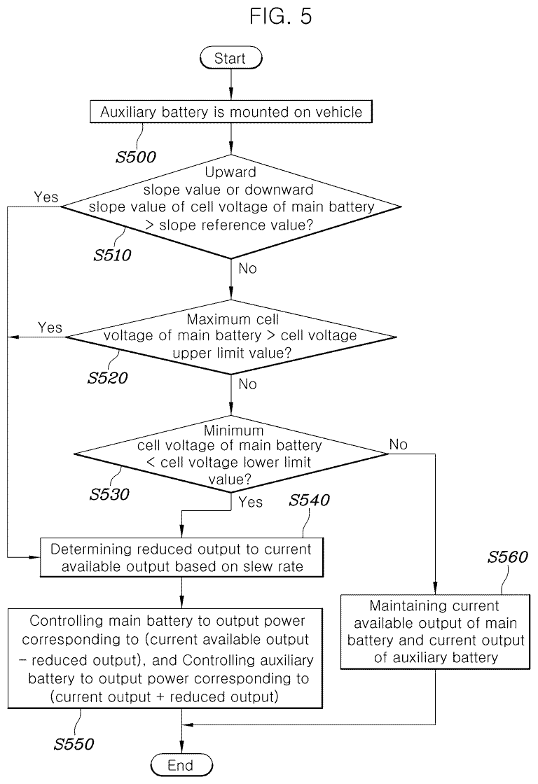

FIG. 5 is a flowchart showing a method for controlling output of the high-voltage battery according to a fourth embodiment of the present disclosure.

Referring to FIGS. 1, 2, and 5, a method for controlling the output of the high-voltage battery according to a fourth embodiment of the present disclosure will be described.

When the first controller 110 recognizes that the auxiliary battery HVB2 is mounted on the vehicle 1, at S500, the first controller 110 may allow the auxiliary battery HVB2 to assist the main battery HVB1, based on the upward slope or the downward slope of cell voltage of the main battery HVB1 or cell voltage of the main battery HVB1.

When the upward slope or the downward slope of cell voltage of the main battery HVB1 is greater than the preset slope reference value, or the maximum cell voltage of the main battery HVB1 is greater than the preset cell voltage upper limit value, or the minimum cell voltage of the main battery HVB1 is less than the preset cell voltage lower limit value, the first controller 110 may reduce the available output of the main battery HVB1 according to the preset slew rate.

Specifically, the first controller 110 may determine whether or not a value of the upward slope or the downward slope of cell voltage of the main battery HVB1 is greater than the preset slope reference value, at S510.

At S510, the first controller 110 may determine whether or not a value of the upward slope of cell voltage of the main battery HVB1 is greater than the preset upward slope reference value or a value of the downward slope of cell voltage of the main battery HVB1 is greater than the preset downward slope reference value.

As a result of the determination at S510, when a value of the upward slope or the downward slope of cell voltage of the main battery HVB1 is greater than the preset slope reference value at S510—Yes, the first controller 110 may determine a reduced output to the current available output based on the preset slew rate at S540.

As a result of the determination at S510, when a value of the upward slope or the downward slope of cell voltage of the main battery HVB1 is less than or equal to the preset slope reference value at S510—No, the first controller 110 may determine whether or not the maximum cell voltage of the main battery HVB1 is greater than the preset cell voltage upper limit value, at S520.

As a result of the determination at S510, when the maximum cell voltage of the main battery HVB1 is greater than the preset cell voltage upper limit value at S520—Yes, the first controller 110 may determine the reduced output to the current available output based on the preset slew rate at S540.

As a result of the determination at S510, when the maximum cell voltage of the main battery HVB1 is less than or equal to the preset cell voltage upper limit at S520—No, the first controller 110 may determine whether or not the minimum cell voltage of the main battery HVB1 is less than the preset cell voltage lower limit value at S530.

As a result of the determination at S530, when the minimum cell voltage of the main battery HVB1 is less than the preset cell voltage lower limit value at S530—Yes, the first controller 110 may determine the reduced output to the current available output based on the preset slew rate at S540.

Furthermore, the first controller 110 may control the main battery HVB1 so that the main battery HVB1 outputs power corresponding to a value obtained by subtracting the reduced output according to the slew rate from the current available output of the main battery HVB1, and may control the auxiliary battery HVB2 so that the auxiliary battery HVB2 outputs power corresponding to a value obtained by adding the reduced output to the current output thereof, at S550.

As a result of the determination at S530, when the minimum cell voltage of the main battery HVB1 is less than or equal to the preset cell voltage lower limit value at S530—No, the first controller 110 may maintain the current available output of the main battery HVB1 and the current output of the auxiliary battery HVB2, at S560.

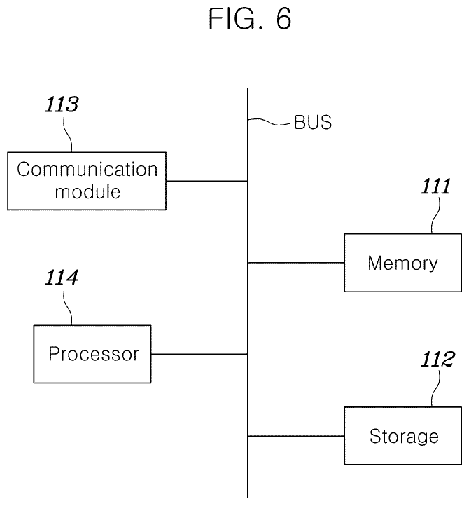

FIG. 6 is a view showing detailed configuration of a first controller according to the present disclosure.

Referring to FIGS. 1 to 6, the first controller 110 according to the present disclosure may include a memory 111, a storage 112, a communication module 113, and a processor 114, and the configuration of the first controller 110 is not limited thereto. The processor 114 may be connected to the memory 111, the storage 112, and the communication module 113 through an inner bus.

The memory 111 may store various algorithms, data, etc. required to operate the processor 114.

The memory 111 may include volatile memory and/or non-volatile memory. The volatile memory may include dynamic random access memory (DRAM), static RAM (SRAM), synchronous DRAM (SDRAM), phase-change RAM (PRAM), magnetic RAM (MRAM), resistive RAM (RRAM), ferroelectric RAM (FeRAM), etc. The non-volatile memory may include read-only memory (ROM), programmable ROM (PROM), electrically programmable ROM (EPROM), electrically erasable programmable ROM (EEPROM), flash memory, etc.

The storage 112 may store data obtained when the processor 114 is operated. For example, the storage 112 may include a medium such as a hard disk drive (HDD), a solid state disk (SSD), an embedded multimedia card (eMMC), and a universal flash storage (UFS).

The storage 112 may store data or information that is obtained or generated in a process where the processor 114 performs the output control for the high-voltage battery for a vehicle.

The communication module 113 may transmit or receive the information through communication with an external device and may transmit the received information to the processor 114.

The communication module 113 may receive the status information, a mounting recognition signal about the auxiliary battery HVB2, which is supplied from the second controller 120, and transmit the information to the processor 114.

The communication module 113 may receive the required output of the vehicle provided by an upper controller and transmit the required output to the processor 114.

The processor 114 may perform calculations or data processing for the control of at least one of the other components of the first controller 110. For example, the processor 114 may perform the algorithm, etc. stored in the memory 111.

The processor 114 may process the received data and the stored data in the memory 111. The processor 114 may perform a code (e.g., algorithm) that is readable by a computer and stored in the memory 111 and instructions caused by the processor 114.

The processor 114 may be a data processing device that is implemented into hardware having a circuit having a physical structure to perform desired operations. For example, the desired operations may include a code or instructions that are included in a program.

For example, the data processing device implemented into hardware may include a microprocessor, a central processing unit, a processor core, a multi-core processor, a multiprocessor, an application-specific integrated circuit (ASIC), and a field programmable gate array (FPGA).

The processor 114 may recognize (or determine) whether or not the auxiliary battery HVB2 is mounted on the vehicle 1, according to a preset method.

For example, the processor 114 may receive the mounting recognition signal output from the second controller 120 and recognize that the auxiliary battery HVB2 is mounted.

For example, the processor 114 may recognize the mounting of the auxiliary battery HVB2 based on a change of voltage of a wire that connects the main battery HVB1 to the auxiliary battery HVB2.

The processor 114 may perform the method for controlling the output of the high-voltage battery according to the first embodiment of the present disclosure.

Specifically, the processor 114 may determine whether or not the required output of the vehicle is the maximum required output of the vehicle, and in response to a result of the determination, the processor 114 may control the output of the main battery HVB1 and the output of the auxiliary battery HVB2.

When the required output of the vehicle is the maximum required output of the vehicle, the processor 114 may control the main battery HVB1 and the auxiliary battery HVB2 so that the main battery HVB1 and the auxiliary battery HVB2 output the maximum power, respectively.

When the required output of the vehicle is not the maximum required output of the vehicle, the processor 114 may control the main battery HVB1 and the auxiliary battery HVB2 based on a result obtained by comparing the value obtained by multiplying the current available output of the main battery HVB1 by the preset conversion proportionality constant α, with the required output of the vehicle.

When the required output of the vehicle is not greater than the value obtained by multiplying the available output of the main battery HVB1 by the conversion proportionality constant α, the processor 114 may control the main battery HVB1 so that the main battery HVB1 outputs power corresponding to the required output of the vehicle.

When the required output of the vehicle is greater than the value obtained by multiplying the available output of the main battery HVB1 by the conversion proportionality constant α, the processor 114 may control the main battery HVB1 so that the main battery HVB1 outputs power corresponding to the value obtained by multiplying the available output of the main battery HVB1 by the conversion proportionality constant α and may control the auxiliary battery HVB2 so that the auxiliary battery HVB2 outputs power obtained by subtracting the output of the main battery HVB1 from the required output of the vehicle.

The processor 114 may perform the method for controlling the output of the high-voltage battery according to the second embodiment of the present disclosure.

Specifically, based on a result of the determination of whether or not the required output of the vehicle is less than the preset threshold value, the processor 114 may control the output of the main battery HVB1 and the output of the auxiliary battery HVB2.

When the required output of the vehicle is equal to or greater than the threshold value, the processor 114 may perform the method for controlling the output of the high-voltage battery according to the first embodiment of the present disclosure.

When the required output of the vehicle is less than the threshold value, the processor 114 may control the output of the main battery HVB1 and the output of the auxiliary battery HVB2 based on a result of the determination of whether or not the operational duration of the main battery HVB1 exceeds the preset time limit.

When the operational duration of the main battery HVB1 exceeds the time limit, the processor 114 may control the auxiliary battery HVB2 so that the auxiliary battery HVB2 outputs the maximum power, and may control the main battery HVB1 so that the main battery HVB1 outputs power corresponding to the value obtained by subtracting the output of the auxiliary battery HVB2 from the required output of the vehicle.

When the operational duration of the main battery HVB1 does not exceed the time limit, that is, the operational duration of the main battery HVB1 is within the time limit, the processor 114 may control the main battery HVB1 so that the main battery HVB1 outputs power corresponding to the required output of the vehicle.

The processor 114 may perform the method for controlling the output of the high-voltage battery according to the third embodiment of the present disclosure.

Specifically, the processor 114 may control the output of the main battery HVB1 and the output of the auxiliary battery HVB2 based on the result of the determination of whether or not the continuous operation accumulated energy of the main battery HVB1 exceeds the preset limit value of the accumulated energy.

When the continuous operation accumulated energy of the main battery HVB1 exceeds the limit value of the accumulated energy, the processor 114 may control the auxiliary battery HVB2 so that the auxiliary battery HVB2 outputs the maximum power, and may control the main battery HVB1 so that the main battery HVB1 outputs power corresponding to the value obtained by subtracting the output of the auxiliary battery HVB2 from the required output of the vehicle.

When the continuous operation accumulated energy of the main battery HVB1 does not exceed the limit value of the accumulated energy (in other word, the continuous operation accumulated energy of the main battery HVB1 is within the limit value of the accumulated energy), the processor 114 may control the main battery HVB1 so that the main battery HVB1 outputs power corresponding to the required output of the vehicle.

According to the embodiment, when the operational duration of the main battery HVB1 does not exceed the time limit (in other word, the operational duration of the main battery HVB1 is within the time limit), the first controller 110 may determine whether or not the continuous operation accumulated energy of the main battery HVB1 exceeds the preset limit value of the accumulated energy.

The processor 114 may perform the method for controlling the output of the high-voltage battery according to the fourth embodiment of the present disclosure.

Specifically, the processor 114 may control the output of the main battery HVB1 and the output of the auxiliary battery HVB2 based on the upward slope or the downward slope of cell voltage of the main battery HVB1, or cell voltage of the main battery HVB1.

When the upward slope or the downward slope of cell voltage of the main battery HVB1 is greater than the preset slope reference value, or the maximum cell voltage of the main battery HVB1 is greater than the preset cell voltage upper limit value, or the minimum cell voltage of the main battery HVB1 is less than the preset cell voltage lower limit value, the processor 114 may reduce the available output of the main battery HVB1 according to the preset slew rate.

The processor 114 may determine the reduced output to the current available output of the main battery HVB1 according to the preset slew rate.

Furthermore, the processor 114 may control the main battery HVB1 so that the main battery HVB1 outputs power corresponding to the value obtained by subtracting the reduced output according to the slew rate from the current available output of the main battery HVB1, and may control the auxiliary battery HVB2 so that the auxiliary battery HVB2 outputs power corresponding to the value obtained by adding the reduced output to the current output thereof.

When the upward slope or the downward slope of cell voltage of the main battery HVB1 is less than or equal to the preset slope reference value, and the maximum cell voltage of the main battery HVB1 is less than or equal to the preset cell voltage upper limit value, and the minimum cell voltage of the main battery HVB1 is equal to or greater than the preset cell voltage lower limit value, the processor 114 may maintain the current available output of the main battery HVB1 and the current output of the auxiliary battery HVB2.

Although the preferred embodiments of the present invention have been disclosed in detail with reference to the accompanying drawings, and the present disclosure is not limited to the embodiments and those skilled in the art will appreciate that various modifications, additions, and substitutions are possible, without departing from the spirit and scope of the present disclosure. Therefore, the embodiments disclosed in this specification are not intended to limit the technical idea of the present disclosure but to describe it, and the scope of the technical idea of the present disclosure is not limited by these embodiments. Therefore, it should be understood that the embodiments described above are provided as illustrative and not restrictive. The scope of protection of the present disclosure should be interpreted in accordance with the scope of the claims, and all technical ideas within the equivalent scope should be interpreted as being included in the scope of rights of the present disclosure.

1. A system for controlling output of a high-voltage battery for a vehicle, the system comprising:
a first controller configured to monitor a state of a main high-voltage battery; and
a second controller configured to monitor a state of a auxiliary high-voltage battery,
wherein when the first controller detects that the auxiliary high-voltage battery is mounted on a vehicle, the first controller is configured to control the main high-voltage battery and the auxiliary high-voltage battery, based on a required output of the vehicle, status information about the main high-voltage battery, and status information about the auxiliary high-voltage battery.

2. The system of claim 1, wherein the first controller is configured to determine whether or not the required output of the vehicle is a maximum required output of the vehicle, and when the required output of the vehicle is the maximum required output of the vehicle, the first controller is configured to control the main high-voltage battery and the auxiliary high-voltage battery so that the main high-voltage battery outputs main high-voltage battery maximum power and the auxiliary high-voltage battery outputs auxiliary high-voltage battery maximum power, respectively.

3. The system of claim 1, wherein the first controller is configured to determine whether or not the required output of the vehicle is the maximum required output of the vehicle, and when the required output of the vehicle is less than the maximum required output of the vehicle, the first controller is configured to control the main high-voltage battery and the auxiliary high-voltage battery, based on a result obtained by comparing a value, the value being obtained by multiplying an available output of the main high-voltage battery by a conversion proportionality constant (α, 0<α<1), to the required output of the vehicle.

4. The system of claim 3, wherein when the required output of the vehicle is less than or equal to the value obtained by multiplying the available output of the main high-voltage battery by the conversion proportionality constant, the first controller is configured to block output of the auxiliary high-voltage battery and control the main high-voltage battery so that the main high-voltage battery outputs power corresponding to the required output of the vehicle.

5. The system of claim 3, wherein when the required output of the vehicle is greater than the value obtained by multiplying the available output of the main high-voltage battery by the conversion proportionality constant, the first controller is configured to control the main high-voltage battery so that the main high-voltage battery outputs power corresponding to the value obtained by multiplying the available output of the main high-voltage battery by the conversion proportionality constant, and the first controller is configured to control the auxiliary high-voltage battery so that the auxiliary high-voltage battery outputs power corresponding to a value obtained by subtracting the output of the main high-voltage battery from the required output of the vehicle.

6. The system of claim 1, wherein the first controller is configured to determine whether or not the required output of the vehicle is less than a preset threshold value, and when the required output of the vehicle is less than the preset threshold value, the first controller is configured to control the main high-voltage battery and the auxiliary high-voltage battery based on a result of determination of whether or not an operational duration of the main high-voltage battery exceeds a preset time limit.

7. The system of claim 6, wherein when the operational duration of the main high-voltage battery exceeds the preset time limit, the first controller is configured to control the auxiliary high-voltage battery so that the auxiliary high-voltage battery outputs maximum power, and control the main high-voltage battery so that the main high-voltage battery outputs power corresponding to a value obtained by subtracting the output of the auxiliary high-voltage battery from the required output of the vehicle.

8. The system of claim 6, wherein when the operational duration of the main high-voltage battery is within the preset time limit, the first controller is configured to control the main high-voltage battery so that the main high-voltage battery outputs power corresponding to the required output of the vehicle.

9. The system of claim 6, wherein when the operational duration of the main high-voltage battery is within the preset time limit, the first controller is configured to control the main high-voltage battery and the auxiliary high-voltage battery based on a result of determination of whether or not continuous operation accumulated energy of the main high-voltage battery exceeds a preset limit value of accumulated energy.

10. The system of claim 9, wherein when the continuous operation accumulated energy of the main high-voltage battery exceeds the preset limit value of accumulated energy, the first controller is configured to control the auxiliary high-voltage battery so that the auxiliary high-voltage battery outputs maximum power, and control the main high-voltage battery so that the main high-voltage battery outputs power corresponding to a value obtained by subtracting the output of the auxiliary high-voltage battery from the required output of the vehicle.

11. The system of claim 9, wherein when the continuous operation accumulated energy of the main high-voltage battery is within the preset limit value of accumulated energy, the first controller is configured to control the main high-voltage battery so that the main high-voltage battery outputs power corresponding to the required output of the vehicle.

12. The system of claim 1, wherein the first controller is configured to control the main high-voltage battery and the auxiliary high-voltage battery based on a result of determination of whether or not continuous operation accumulated energy of the main high-voltage battery exceeds a preset limit value of accumulated energy.

13. The system of claim 12, wherein when the continuous operation accumulated energy of the main high-voltage battery exceeds the preset limit value of accumulated energy, the first controller is configured to control the auxiliary high-voltage battery so that the auxiliary high-voltage battery outputs maximum power, and control the main high-voltage battery so that the main high-voltage battery outputs power corresponding to a value obtained by subtracting the output of the auxiliary high-voltage battery from the required output of the vehicle.

14. The system of claim 12, wherein when the continuous operation accumulated energy of the main high-voltage battery is within the preset limit value of accumulated energy, the first controller is configured to control the main high-voltage battery so that the main high-voltage battery outputs power corresponding to the required output of the vehicle.

15. The system of of claim 1, wherein the first controller is configured to control the main high-voltage battery and the auxiliary high-voltage battery based on at least one selected from a group consisting of a change slope value of cell voltage of the main high-voltage battery, maximum cell voltage thereof, and minimum cell voltage thereof.

16. The system of claim 15, wherein when the change slope value of cell voltage of the main high-voltage battery is greater than a preset slope reference value, the maximum cell voltage of the main high-voltage battery is greater than a preset cell voltage upper limit value, or the minimum cell voltage of the main high-voltage battery is less than a preset cell voltage lower limit value, the first controller is configured to reduce an available output of the main high-voltage battery according to a preset slew rate.

17. The system of claim 16, wherein the first controller is configured to control the main high-voltage battery so that the main high-voltage battery outputs power corresponding to a value obtained by subtracting the reduced output according to the slew rate from the available output of the main high-voltage battery, and control the auxiliary high-voltage battery so that the auxiliary high-voltage battery outputs power corresponding to a value obtained by adding the reduced output to a current output of the auxiliary high-voltage battery.

18. The system of claim 15, wherein when the change slope value of cell voltage of the main high-voltage battery is less than or equal to a preset slope reference value, the maximum cell voltage of the main high-voltage battery is less than or equal to a preset cell voltage upper limit value, and the minimum cell voltage of the main high-voltage battery is equal to or greater than a preset cell voltage lower limit value, the first controller is configured to maintain available output of the main high-voltage battery and output of the auxiliary high-voltage battery.

19. A method for controlling output of a high-voltage battery for a vehicle, the method comprising:
monitoring, by a first controller, a state of a main high-voltage battery;
monitoring, by a second controller, a state of an auxiliary high-voltage battery; and
when the auxiliary high-voltage battery is mounted on a vehicle, controlling, by the first controller, the main high-voltage battery and the auxiliary high-voltage battery, on a basis of a required output of the vehicle, status information about the main high-voltage battery, and status information about the auxiliary high-voltage battery.

20. A vehicle comprising a system for controlling output of a high-voltage battery for a vehicle,
wherein the system for controlling output of a high-voltage battery for a vehicle comprises:
a first controller configured to monitor a state of a main high-voltage battery; and
a second controller configured to monitor a state of a auxiliary high-voltage battery,
wherein when the first controller detects that the auxiliary high-voltage battery is mounted on a vehicle, the first controller is configured to control the main high-voltage battery and the auxiliary high-voltage battery, on a basis of a required output of the vehicle, status information about the main high-voltage battery, and status information about the auxiliary high-voltage battery.
